(19) United States
(12) Patent Application Publication
(10) Pub. No.: US 2009/0040170 A1
(43) Pub. Date: Feb. 12, 2009

(54) ELECTRONIC DEVICE COMPRISING A DISPLAY WITH ADJUSTABLE BRIGHTNESS, CHROMATICITY OR BOTH

(75) Inventor: Rene NILSSON, Eslov (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/836,878

(22) Filed: Aug. 10, 2007

(51) Int. Cl. G09G 3/36

(52) U.S. Cl. 345/101

(57) ABSTRACT

An electronic device, a method and a computer program product for controlling the operation of a display. The electronic device comprises a display for displaying an RGB (Red/Green/Blue) image, a lighting device coupled to the display for supplying light to the display for enabling display operation thereof, and a color temperature detecting device configured to detect a color temperature of ambient light. A controller is coupled to the lighting device and the color temperature detecting device. The controller then controls the lighting of the lighting device in dependence of the detected color temperature of the ambient light in order to correct brightness or chromaticity or both of an RGB image displayed on the display.

### TECHNICAL FIELD

The present invention relates in general to electronic devices, e.g. mobile phones, having a display. More particularly, the present invention relates to an electronic device having a display with adjustable brightness or chromaticity or both. The present invention also relates to a method and a computer program product for controlling the operation of a display such that the brightness or the chromaticity or both of said display may be adjusted.

### BACKGROUND

Electronic devices such as mobile phones, smart phones, Personal Digital Assistants (PDA's), media players, computers and the like are widely used today. The first commercially attractive mobile terminals and mobile phones were introduced in the market in the end of the 1980's. Since then, the mobile communications industry has had an enormous development both regarding quality of service and transmission capabilities, as well as the technology for producing advanced communications terminals.

Electronic devices such as mobile phones are known to include a display. Generally speaking, along with mobile phone advancing technology, customers nowadays pay more attention to color screen mobile phones; if color screen mobile phones were launched in 2002, then 2003 was the year for color screen mobile phones to really become popular among people. Approximately four years ago color screen mobile phones stood for new fashion, the bright colors attracted people's attention along with major manufacturers rolling out new mobile phone models continuously. Today, color screen mobile phones have almost replaced the earlier mono screen mobile phones. Nowadays major manufacturers may focus on two markets, one is the high price and high end color screen mobile phone market, another one is lower cost and low end color screen mobile phone market. In the high end market, manufacturers generally compete with advanced technology and powerful functions. In the low end market, manufacturers generally compete with applicable function and reasonable price/performance ratio.

Concerning color screen mobile phones, the display effect is becoming a parameter of increasing concern. Furthermore, with known prior art displays the readability may be poor under certain lighting conditions. Accordingly, there may be a need for improved displays, e.g. with improved readability under certain lighting conditions.

### SUMMARY OF THE INVENTION

An aspect of the present invention relates to an electronic device, comprising: a display operable to display an RGB (Red/Green/Blue) image; a lighting device coupled to the display for supplying light to the display for enabling display operation thereof; a color temperature detecting device configured to detect a color temperature of ambient light; and a controller coupled to the lighting device and the color temperature detecting device, wherein the controller is configured to control the lighting of the lighting device in dependence of the detected color temperature of the ambient light in order to correct brightness or chromaticity or both of an RGB image displayed on the display.

In one embodiment, the color temperature detecting device is configured to detect an intensity of each color component of the ambient light as the amount of an electrical charge excited and accumulated according to a quantity of the incident light; to obtain a time length signal by detecting a discharge time of the electrical charge; to produce a first control signal according to the time length signal as color temperature information; and to send said first control signal to the controller.

In one embodiment, the controller is configured to receive the first control signal and in response thereto send a second control signal to the lighting device when a certain color temperature of the ambient light is detected by the color temperature detecting device, the second control signal requesting the lighting device to correct brightness or chromaticity or both of the displayed RGB image on the basis of the detected certain color temperature; and the lighting device is configured to receive said second control signal and in response thereto generate the certain correction when supplying light to the display.

In one embodiment, the color temperature detecting device is configured to detect the color temperature of the ambient light by means of a light receiving system.

In one embodiment, the light receiving system is a camera.

In one embodiment, the camera is positioned adjacent to the display in such way that its field-of-view is likely to cover a user watching the display.

In one embodiment, the electronic device is a portable radio communication equipment.

In one embodiment, the electronic device is a mobile radio terminal.

In one embodiment, the electronic device is a mobile phone.

In one embodiment, the electronic device is a cellular phone.

In one embodiment, the electronic device is a pager.

In one embodiment, the electronic device is a communicator.

In one embodiment, the electronic device is an electronic organizer.

In one embodiment, the electronic device is a smart phone.

In one embodiment, the electronic device is a camera device.

In one embodiment, the electronic device is a media player.

Another aspect of the invention relates to a method of controlling the operation of a display, the method comprising:

supplying light to a display for enabling display operation thereof;

displaying an RGB (Red/Green/Blue) image on the display;

detecting the color temperature of ambient light; and

controlling the lighting in dependence of the detected color temperature of the ambient light in order to correct brightness or chromaticity or both of the RGB image displayed on the display.

In one embodiment, the detecting comprises:

detecting an intensity of each color component of the ambient light as the amount of an electrical charge excited and accumulated according to a quantity of the incident light;

obtaining a time length signal by detecting a discharge time of the electrical charge; and

producing a control signal according to the time length signal as color temperature information.

Said control signal may subsequently be used for the controlling.

Still another aspect of the invention relates to a computer program product comprising computer program code means for controlling the operation of a display when said computer program code means is executed by means of an electronic device having computer capabilities, the computer program code means comprising:

code means for displaying an RGB (Red/Green/Blue) image on the display;

code means for supplying light to the display for enabling display operation thereof;

code means for detecting the color temperature of ambient light; and

code means for controlling the lighting in dependence of the detected color temperature of the ambient light in order to correct brightness or chromaticity or both of the RGB image displayed on the display.

In one embodiment, the code means for detecting the color temperature of ambient light, comprises:

code means for detecting an intensity of each color component of the ambient light as the amount of an electrical charge excited and accumulated according to a quantity of the incident light;

code means for obtaining a time length signal by detecting a discharge time of the electrical charge; and

code means for producing a control signal according to the time length signal as color temperature information.

Some embodiments of the invention provide for a solution, which improves the color representation of displayed images under various lighting conditions. It is an advantage with some embodiments of the invention that the readability may be enhanced, as compared to known prior art solutions.

### BRIEF DESCRIPTION OF THE DRAWINGS

Further objects, features and advantages of the present invention will appear from the following detailed description of the invention, wherein embodiments of the invention will be described in more detail with reference to the accompanying drawings, in which:

FIG. 1A is a schematic front view of an electronic device embodied as a mobile phone;

FIG. 1B is a schematic side view of the electronic device of FIG. 1A;

FIG. 1C is a schematic rear view of the electronic device of FIG. 1A;

FIG. 2 is a block diagram of an embodiment of the electronic device illustrated in FIG. 1; and

FIG. 3 is a flowchart of a method in accordance with an embodiment of the invention.

### DETAILED DESCRIPTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

Some embodiments of the present invention stem from the inventor's realization that the color temperature of ambient light affects the perceived color of an image, e.g. an RGB (Red/Green/Blue) image, displayed on the display of an electronic device. According to some embodiments of the invention, the brightness or the chromaticity or both is/are controllable on the basis of a detected color temperature of ambient or incident light, and so the brightness or the chromaticity or both of said display can be adjusted with respect to the detected ambient color temperature. As used herein, the term brightness refers to an attribute of visual perception in which a source, i.e. the display in this case, appears to emit a given amount of light. In the RGB color space, brightness may be thought of as the arithmetic mean μ of the Red, Green and Blue color coordinates (although some of the color components make the light seem brighter than others):

$$μ = \frac{R + G + B}{3}$$

Furthermore, the term chromaticity as used herein refers to the quality of a color as determined by its purity and its hue. In color theory, purity refers to the intensity of a specific hue. In an RGB color space, purity may be thought of as the standard deviation σ of the color coordinates Red, Green and Blue. Letting μ represent the brightness defined as the mean of R, G, and B, then:

$$σ = \sqrt{\frac{{( R - μ )}^{2} + {( G - μ )}^{2} + {( B - μ )}^{2}}{3}}$$

Since the inventor has realized that the perceived color of a displayed image is affected by the color temperature of ambient light, it is a great advantage with some embodiments of the present invention that they provide for a display whose brightness or chromaticity or both can be adjusted in dependence of the detected color temperature of ambient or incident light. As compared to known prior art color displays, an improved color reproduction, e.g. in various lighting conditions, can thus provided by some embodiments of the present invention. Further details will be disclosed below.

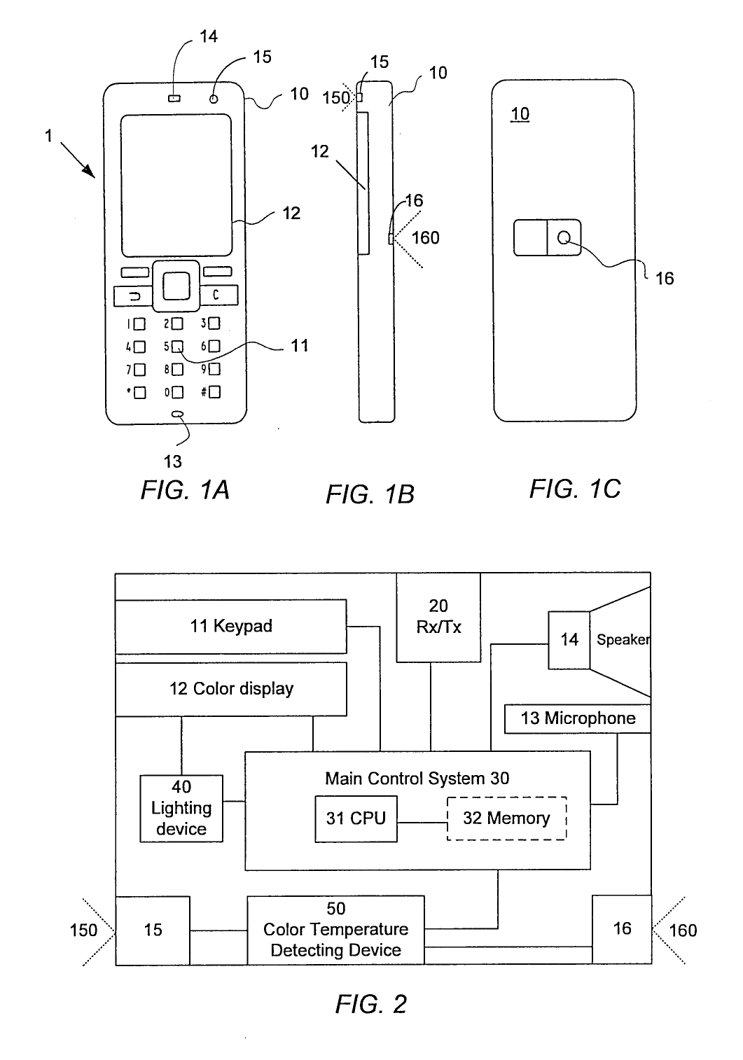

An electronic device, embodied as a mobile phone 1, configured in accordance with an exemplary embodiment of the present invention is shown from three different angles in FIGS. 1A-1C, and in the form of a block diagram in FIG. 2. It should be appreciated that embodiments of the present invention may be implemented into a wide variety of electronic devices. The electronic device may e.g. be a portable radio communication equipment, a mobile radio terminal, a cellular phone, a pager, a communicator, an electronic organizer, a smart phone, a camera device, a media player, etc. Reference will however be to the mobile phone 1, which is only for illustrative purpose and should not be considered as limiting to the embodiments of the invention set forth herein.

The mobile phone 1 comprises a support structure 10 including a housing and a chassis, arranged to support other elements of the device. A user interface includes a keypad or keyboard 11 and a display 12, e.g. a Liquid Crystal Display (LCD), for displaying an image such as an RGB (Red/Green/Blue) image. Typically, the mobile phone 1 also includes an audio interface including a microphone 13, a speaker 14, and radio transceiver (Rx/Tx) circuitry as well as antenna 20, even though these elements are not of importance for the invention and can be dispensed with if embodiments of the invention are employed in another electronic device, e.g. in a media player such as a MP3-player or iPod™. Besides, the specific function and design of the mobile phone 1 as a communication device is known to persons skilled in the art, and will therefore not be described in any further detail herein. Normally a battery (not shown) is also included in the mobile phone 1. A main control system 30 is built-in into the mobile phone 1 to control the operation of the mobile phone 1. The main control system 30 may include a controller such as a CPU 31, a memory unit 32, a graphic control circuitry (not shown) and corresponding software (not shown). The CPU 31 may be configured to do arithmetic and logic operations given instructions to send the data to the right components after calculation. The memory unit 32 may comprise a ROM memory to store routines with special functions and system program. The memory unit 32 may also comprise a RAM memory which is controlled by the CPU 31. The RAM memory may be the main storage area of the mobile phone 1 to store conditional instructions and preset data. The graphic control circuitry may be configured to process graphic functions. For instance, if the display 12 receives display conditional instructions from the main control system 30, the display screen may then display colors and pictures accordingly. Furthermore, a lighting device 40 is coupled to the display 12 for supplying light to the display 12 that the display 12 needs for its display operation. It should be noted that the list of features and elements included in the mobile phone 1 is in no way exhaustive. On the contrary, while the mobile phone 1 shown and described represents only one possible embodiment, it may well comprise further features and elements providing other functions.

Apart from the elements outlined above, the mobile phone 1 may further include a first digital camera 16, an aperture of which is indicated in FIG. 1C. A second digital camera 15 may also be included, positioned adjacent to display 12, and aimed such that its field-of-view 150 is likely to cover a user watching display 12. The two cameras 15 and 16 may be aimed at substantially opposite directions as illustrated in FIGS. 1A-1C, but they may optionally be directed approximately 90° to each other. It is in fact not essential that the two cameras 15 and 16 have fixed line of sights, the primary camera 16 could indeed e.g. be rotatable in a socket in support structure 10 to some extent.

A target of some embodiments of the present invention is to provide a mobile phone 1 having a display which enables for an improved perceived color representation of an RGB image displayed on the display 12. To attain this, the mobile phone comprises a color temperature detecting device 50, e.g. as illustrated in FIG. 2. According to one embodiment, the color temperature detecting device 50 is configured to detect the color temperature of ambient or incident light by means of a light receiving system, e.g. by means of either of or both of the cameras 15 and 16. It may be advantageous to utilize the camera 15, which is positioned adjacent to display 12 and aimed such that its field-of-view 150 is likely to cover a user watching display 12. This is because, then, the color temperature detecting device is capable of detecting the color temperature of ambient light in proximity to the display 12.

In one exemplary implementation of the color temperature detecting device 50, the color temperature detecting device 50 comprises color component detecting means for detecting electric charges for color components excited by incident light and accumulated with the lapse of time to produce color component signals; comparison means for comparing the color component signals with respective given reference signals to produce time length signals which are proportional to the respective accumulated amounts of the electric charges; and an output part for obtaining a ratio between the color components on the basis of the time length signals produced from the comparison means to produce signals according to the ratio as color temperature information. This implementation of the color temperature detecting device is arranged to detect the intensity of each color component of the incident light as the amount of the electrical charge excited and accumulated according to the quantity of the incident light; to obtain a time length signal by detecting the discharge time of the electrical charge; and finally to produce a control signal according to the time length signal as color temperature data or information. This way, a relatively simple and inexpensive arrangement, which is capable of detecting the color temperature of incident light having a relatively wide range of luminance values, is provided.

In this embodiment, the CPU 31 of the main control system 30 is configured to receive the above-mentioned control signal, corresponding to the detected color temperature information and produced by the color detecting device 50. Based on the detected certain color temperature of the ambient light, the CPU 31 is configured to send another control signal to the lighting device 40, said control signal requesting the lighting device 40 to correct brightness or chromaticity or both of the displayed RGB image on the basis of the detected certain color temperature. The lighting device 40 is configured to receive said control signal from the CPU 31 and in response thereto generate the certain correction when supplying light to the display 12. In other words, based on the color temperature information, the CPU 21 is configured to control the lighting of the lighting device 40 in order to correct the brightness or the chromaticity or both of an RGB image displayed on the display 12. Accordingly, an RGB image which is displayed on the display 12 can be adjusted in dependence of detected ambient color temperature conditions.

So, the color temperature detecting device 50 of the mobile phone 1 detects the color temperature of the ambient light conditions and transmits this data or information to the main control system 30 as the original color temperature data to be analyzed. The main control system 30 compares the data collected with preset data stored in the memory unit. The CPU 31 is configured to control the lighting of the lighting device 40 in dependence of the detected color temperature of the ambient light in order to correct brightness or chromaticity or both of an RGB image displayed on the display. Consequently, if the collected data is in a certain range, the CPU 31 transmits a control signal to the lighting device 40 to adjust the brightness or chromaticity or both of an RGB image displayed on the display. When the ambient color temperature changes, the color temperature detecting device 50 may compare any new color temperature data with pre-set data stored in the memory unit and subsequently alter the brightness or chromaticity or both of the display if the change in color temperature is such that a correction is appropriate. Since the displayed RGB image can be adjusted in dependence of the color temperature of the ambient light conditions, a user may e.g. be helped to clearly read on the display 12. In other words, the readability (e.g. in poor viewing conditions) may be improved by some embodiments of the present invention. Furthermore, improved color reproduction under various lighting conditions may be provided.

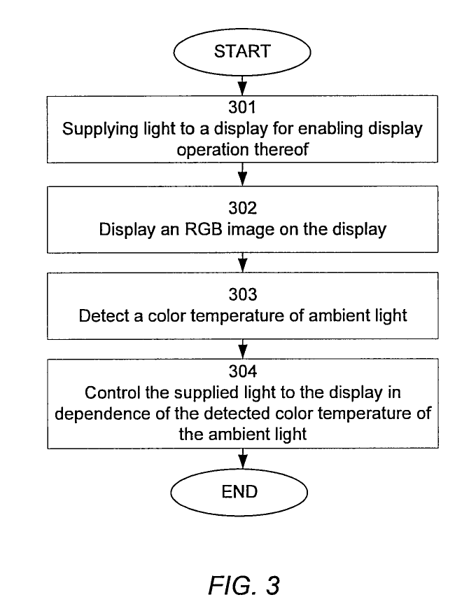

FIG. 3 illustrates schematically a method of controlling the operation of a display of an electronic device 1 in accordance with an embodiment of the invention. In step 301, light is supplied by means of a lighting device 40 to the display 12 for enabling display operation thereof. In step 302, an RGB image is displayed on the display 12 of the electronic device 1. In step 303, a color temperature of ambient or incident light is detected by means of a color temperature detecting device 50. The detection performed by color temperature detecting device 50 of the color temperature may be performed continuously. As an alternative, the detection of the color temperature may be performed at certain time intervals, which could be either pre-programmed or, alternatively, be edited or programmed by the user of the electronic device 1 by interacting with and operating the user interface of electronic device 1. As a further alternative, the detection of the color temperature could be performed on demand by interacting with and operating the user interface of electronic device 1. Then, in step 304, the lighting is controlled in dependence of the detected color temperature of the incident or ambient light in order to correct brightness or chromaticity or both of the displayed RGB image. Since the color temperature of ambient light affects the perceived color of an RGB image displayed on the display of the electronic device, it is an advantage with the method that it provides for controlling the lighting effects of the display such that the brightness or chromaticity or both is adjusted in dependence of detected color temperature of ambient light. As compared to known prior art color displays, an improved color reproduction of displayed RGB images, e.g. under various lighting conditions, can hence be provided.

The above-mentioned method may be executed by computer program code means to make an electronic device having computer capabilities, e.g. a mobile phone, execute the method when the computer program code means is run by the electronic device having computer capabilities. Also, the computer program code means may be embodied on a computer readable medium, such as a memory.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. An electronic device, comprising:
a display operable to display an RGB (Red/Green/Blue) image;
a lighting device coupled to the display for supplying light to the display for enabling display operation thereof;
a color temperature detecting device configured to detect a color temperature of ambient light; and
a controller coupled to the lighting device and the color temperature detecting device, wherein the controller is configured to control the lighting of the lighting device in dependence of the detected color temperature of the ambient light in order to correct brightness or chromaticity or both of an RGB image displayed on the display.

2. The electronic device as recited in claim 1, wherein:
the color temperature detecting device is configured to detect an intensity of each color component of the ambient light as the amount of an electrical charge excited and accumulated according to a quantity of the incident light; to obtain a time length signal by detecting a discharge time of the electrical charge; to produce a first control signal according to the time length signal as color temperature information; and to send said first control signal to the controller.

3. The electronic device as recited in claim 2, wherein:
the controller is configured to receive the first control signal and in response thereto send a second control signal to the lighting device when a certain color temperature of the ambient light is detected by the color temperature detecting device, the second control signal requesting the lighting device to correct brightness or chromaticity or both of the displayed RGB image on the basis of the detected certain color temperature; and
the lighting device is configured to receive said second control signal and in response thereto generate the certain correction when supplying light to the display.

4. The electronic device as recited in claim 1, wherein the color temperature detecting device is configured to detect the color temperature of the ambient light by means of a light receiving system.

5. The electronic device as recited in claim 4, wherein the light receiving system is a camera.

6. The electronic device as recited in claim 5, wherein the camera is positioned adjacent to the display in such way that its field-of-view is likely to cover a user watching the display.

7. The electronic device as recited in claim 1, wherein the electronic device is a device from the group comprising: a portable radio communication equipment, a mobile radio terminal, a mobile phone, a cellular phone, a pager, a communicator, an electronic organizer, a smart phone, a camera device, a media player.

8. A method of controlling the operation of a display, the method comprising:
supplying light to a display for enabling display operation thereof;
displaying an RGB (Red/Green/Blue) image on the display;
detecting a color temperature of ambient light;
controlling the lighting in dependence of the detected color temperature of the ambient light in order to correct brightness or chromaticity or both of the RGB image displayed on the display.

9. The method as recited in claim 8, wherein the detecting comprises:
detecting an intensity of each color component of the ambient light as the amount of an electrical charge excited and accumulated according to a quantity of the incident light;
obtaining a time length signal by detecting a discharge time of the electrical charge; and
producing a control signal according to the time length signal as color temperature information;
and wherein said control signal is subsequently used for the controlling.

10. A computer program product comprising computer program code means for controlling the operation of a display when said computer program code means is executed by means of an electronic device having computer capabilities, the computer program code means comprising:
code means for displaying an RGB (Red/Green/Blue) image on the display;
code means for supplying light to the display for enabling display operation thereof;
code means for detecting the color temperature of ambient light; and
code means for controlling the lighting in dependence of the detected color temperature of the ambient light in order to correct brightness or chromaticity or both of the RGB image displayed on the display.

11. The computer program product as recited in claim 10, wherein the code means for detecting the color temperature of ambient light comprises:
code means for detecting an intensity of each color component of the ambient light as the amount of an electrical charge excited and accumulated according to a quantity of the incident light;
code means for obtaining a time length signal by detecting a discharge time of the electrical charge; and
code means for producing a control signal according to the time length signal as color temperature information.
